(19) United States
(12) Patent Application Publication
(10) Pub. No.: US 2010/0031096 A1
(43) Pub. Date: Feb. 4, 2010

(54) INTERNAL FAIL BIT OR BYTE COUNTER

(76) Inventors: Ercole Rosario Di Iorio, Scurcola Marsicana (IT); Violante Moschiano, Bacoli (IT); Emanuele Sirizotti, Avezzano (IT); Luca DeSantis, Avezzano (IT); Maria Luisa Gallese, Via Bultrini (IT)

Correspondence Address: COOL PATENT, P.C.;c/o CPA Global, P.O. BOX 52050, MINNEAPOLIS, MN, 55402, US

(21) Appl. No.: 12/184,002

(22) Filed: Jul. 31, 2008

(51) Int. Cl. G06F 11/00

(52) U.S. Cl. 714/704; 714/E11.004

(57) ABSTRACT

Briefly, in accordance with one or more embodiments, an internal fail byte counter is disclosed.

### BACKGROUND

### Technical Field

The disclosure relates to electrically-erasable programmable read only memory (EEPROM) devices, more particularly the disclosure relates to counting bit and/or byte failures in an EEPROM.

### BRIEF DESCRIPTION OF THE DRAWINGS

FIG. 1 is a diagram illustrating a particular embodiment of an internal fail bit counting circuit.

FIG. 2 is a timing diagram for a particular embodiment of an internal fail bit counting circuit.

FIG. 3 is a diagram illustrating a particular embodiment of an internal fail bit counting circuit.

FIG. 4 is a state diagram illustrating transition states of a particular embodiment of an internal fail bit counting circuit.

FIG. 5 is a state diagram illustrating transition states of a particular embodiment of an internal fail bit counting circuit.

FIG. 6 is a block diagram illustrating a particular embodiment of an internal fail bit counting process.

FIG. 7 is a diagram illustrating a particular embodiment of an internal fail bit counting circuit.

FIG. 8 is a block diagram illustrating a particular embodiment of an internal fail bit counting circuit.

FIG. 9 is a block diagram illustrating a particular embodiment of an internal fail bit counting process.

### DETAILED DESCRIPTION

In the following detailed description, numerous specific details are set forth in order to provide a thorough understanding of claimed subject matter. However, it will be understood by those skilled in the art that claimed subject matter may be practiced without these specific details. In other instances, well-known methods, procedures, and components have not been described in detail so as not to obscure claimed subject matter.

Throughout the following disclosure the term ‘NAND’ is used and is intended to refer to the logic function ‘not-AND’. The term ‘NAND flash’ is used throughout the disclosure and is intended to refer to a flash EEPROM device that employs tunnel injection for writing and tunnel release for erasing.

Particular embodiments described herein refer to NAND Flash EEPROM memory devices, however, in other embodiments the following disclosed device and method may be used in a variety of memory devices known to those of ordinary skill in the art and claimed subject matter is not so limited.

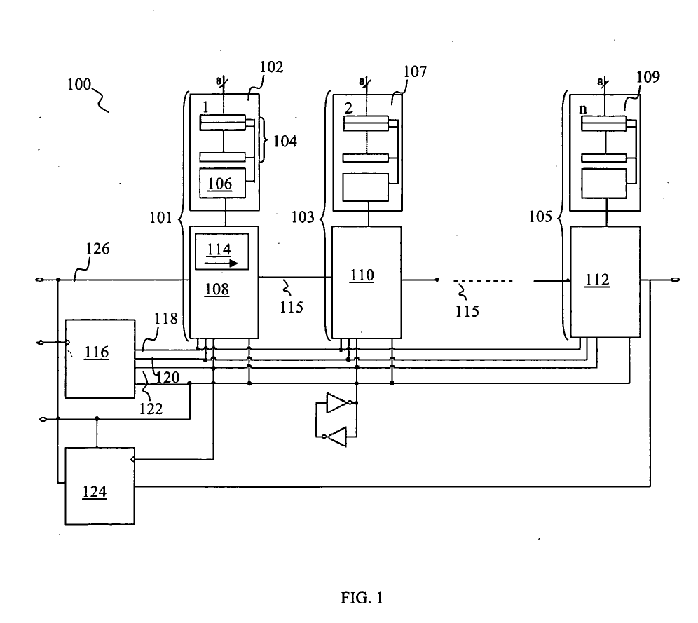

FIG. 1 is a conceptual schematic diagram of a particular embodiment of circuit 100 operable to count failing bytes in a memory device. In a particular embodiment, circuit 100 may comprise a memory array coupled to a memory buffer 102. Memory buffer 102 may comprise a number of bytes of memory. In a particular embodiment, a byte may be composed of eight bits. A bit may have its own memory element which may comprise two or three memory cells and logic. In a particular embodiment, buffer 102 may temporarily store data to be read or written from or to an array page and may enable other array operations such as verify, program, and etc.

According to a particular embodiment, during programming, verification circuitry may evaluate bits in a byte and generate a failed byte signal if at least one bit of a byte has not been correctly programmed. According to a particular embodiment, circuit 100 may count the number of failing bytes, notifying a memory controller whether the number of failing bytes exceeds a tolerated amount of fails (K).

In a particular embodiment, a ‘failed bit’ or ‘failed byte’ is a bit or byte that may be programmed incorrectly and/or may not be programmed at all. In a particular embodiment, circuit 100 may comprise a sequence of failed byte counting assemblies; first FBCA 101, second FBCA 103 and nth FBCA 105. Such a sequence may comprise any appropriate number of FBCAs. In the following detailed description of FIG. 1, only first FBCA 101 will be discussed in detail, however, other FBCAs of circuit 100 may function in a similar way to first FBCA 101 and claimed subject matter is not limited in this regard.

According to a particular embodiment, FBCA 101 may comprise, memory buffer 102 comprising 1−n data cache (DC) 104 and data detector (DDTC) 106. DCs 104 may comprise bytes of eight bits. In a particular embodiment, memory buffer 102 may be coupled to failed byte counting unit (FBCU) 108. DDTC 106 may comprise circuitry operable to determine whether bytes associated with an array page have been programmed properly. During a programming operation, DDTC 106 may check for failing bits in 1−n DC 104. If DDTC 106 detects a failed or improperly programmed bit, DDTC 106 may generate a “failed byte signal.” Thus, a failed byte signal, when asserted may indicate that at least one bit of a byte in any of 1−n DC 104 has been incorrectly programmed or not programmed at all.

In a particular embodiment, first FBCU 108 may be coupled to memory buffer 102. DDTC 106 may be capable of communicating to first FBCU 108 that there is at least one failed byte in memory buffer 102 in one or more of 1−n DC 104. According to a particular embodiment, first FBCU 108 may be coupled to additional Fail Byte Counting Units second FBCU 110 through nth FBCU 112. According to a particular embodiment, FBCU 110 and FBCU 112 may be coupled to respective memory buffers 107 and 109. FBCU 110 and FBCU 112 may also be capable of receiving failed byte signals.

According to a particular embodiment, a counting process may be enabled in a first FBCU 108 if a start signal 126 is asserted. Start signal 126 may also enable counter 124. In a particular embodiment, token 114 may be generated in response to start signal 126. FBCUs 108, 110 and 112 may be coupled via an enable signal chain 115 comprising enable signals 1−n, which may enable token 114 to cascade through FBCUs coupled via enable signal chain 115.

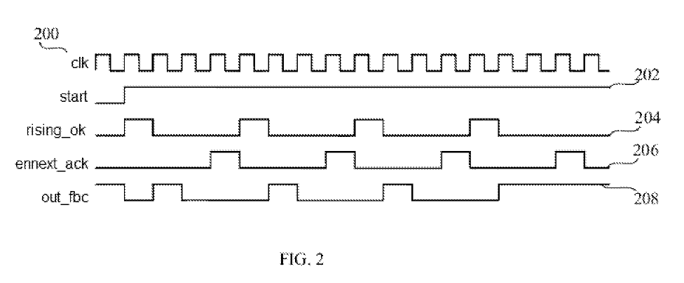

According to a particular embodiment, token 114 propagation and signal induction may be managed at least in part by State Machine (SM) 116 via control signals ‘ennext_ack’ 118 and ‘rising_ok’ 120. A particular embodiment of control signals ‘ennext_ack’ 118 and ‘rising_ok’ 120 signals are discussed in further detail with respect to FIG. 2.

Referring still to FIG. 1, in a particular embodiment, if first FBCU 108 receives a fail byte signal from DDTC 106, token 114 may generate a pulse out on line out_fbc in response to such a fail byte signal. FBCU 108 may send such a pulse out on line out_fbc by a variety of other methods know to those of skill in the art and claimed subject matter is not limited in this regard. In a particular embodiment, after a pulse is generated, token 114 may be released to proceed to a subsequent FBCU, such as, second FBCU 110 via enable chain 115.

In a particular embodiment, counter 124 may count pulses generated in response to fail byte signals sent on out line out_fbc. Accordingly, circuit 100 may be able to count the total number of failing bytes determined in 1−n FBCA 101, 102 and 105.

According to a particular embodiment, circuit 100 may communicate a number of failing bytes calculated in counter 124 to a memory controller (not shown) or other processor running a programming algorithm that requests read/write data from a particular area of memory. Such a controller or processor may compare a number of failing bytes calculated by circuit 100 to a tolerated amount of fails for a particular function.

In a particular embodiment, in contrast to conventional methods, circuit 100 may enable counting of K failed bytes by waiting a time proportional to K, rather than scanning all of the n fail byte signals generated by all DCs in a page or sector selected for byte verification. For instance, in a particular embodiment, a threshold K of failed bytes may be predetermined. A sequence, which generates an out_fbc pulse for detection of a failed bit in a byte may take a number of clock cycles, Nclk. Accordingly, counting of a threshold number of failing bytes may take Nclk*K*Tclk where Tclk is the clock period with no delay.

In a particular embodiment, propagating a token though an FBCU where no failed byte signal is generated may delay propagation of a token by Tdel. In a particular embodiment, such delay may be on the order of 300 ps-500 ps. Thus, the time to count at least K failing bytes in a page comprising n bytes where there n-K DCs having no failed bytes may be equal to:

Tk=Nclk*K*Tclk+(n−K)*Tdel

FIG. 2 illustrates a particular embodiment of a timing diagram 200 for signal propagation and control in circuit 100. In a particular embodiment, token 114 (shown in FIG. 1) may be generated in FBCU 108 (shown in FIG. 1) by a rising edge of start signal 202. In a particular embodiment, propagation of token 114 may be controlled by fail byte signals (not shown) and state machine 116 (see FIG. 1) control signals, such as, for instance, ennext_ack 206 and rising_ok 204.

In a particular embodiment, if FBCU 108 receives a fail byte signal, a pulse may be generated by token 114 and sent out on out_fbc line 208. However, if FBCU 108 receives a de-asserted fail byte signal or there is no fail byte signal then token 114 may be released without generating a pulse on out_fbc line 208. According to a particular embodiment, subsequent FBCU may receive token 114 via an enable chain.

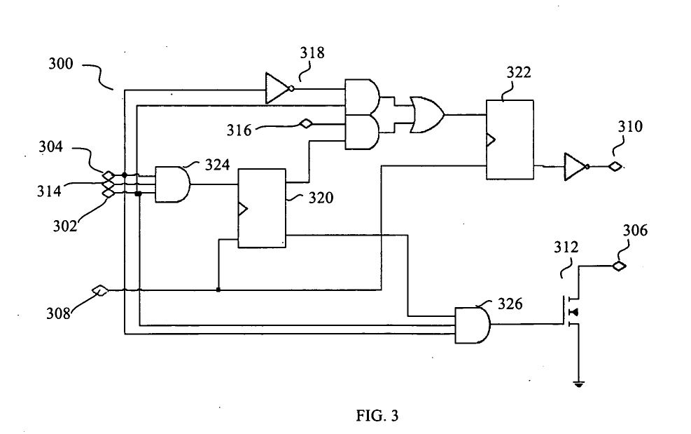

FIG. 3 illustrates a circuit diagram for a particular embodiment of a fail bit counting unit, FBCU 300. In a particular embodiment, a failed byte counting process may start by asserting a start signal 302. For a first FBCU, start signal 302 may be similar to enable signals for subsequent FBCUs. Therefore, the following detailed discussion describes FBCU 300 in a transition state for a first FBCU wherein SM 116 (shown in FIG. 1) and FBCU 300 have been reset via reset signal 308 and may be in an initial state.

In a particular embodiment, when there are no failed bytes in a page, failed byte signal 304 may be low. According to a particular embodiment, start signal 302 (or enable signal for subsequent FBCUS) may be asserted. According to a particular embodiment, not fail signal 318 may indicate that there are no failed bytes for a byte corresponding to FBCU 300. Accordingly, FBCU 300 may assert an enable out signal (en_out) 310 releasing a token (not shown) and enabling subsequent FBCUs. In a particular embodiment, SM 116 may act as a sequencer. When there are no failed bytes to count (such as when failed byte signal=L) SM 116 may not start sequencing and no output signal (out_fbc) 306 may be asserted.

In a particular embodiment, if there are failed bytes in a page to count. According to a particular embodiment, failed byte signal 304 may be high. According to a particular embodiment, start signal 302 may be asserted. After a rising edge of start signal 302 is detected, FBCU 300 may generate a negative edge by activating a pull down NMOS 312 on line out_fbc 306. According to a particular embodiment, SM 116 may sample a negative edge of signal out_fbc 306 as SM 116 is entering a Q1 state where SM 116 may activate an output signal rising_ok 314. Correspondingly, if FBCU 300 detects output signal rising_ok 314, FBCU 300 may deactivate NMOS 312, enabling signal out_fbc 306 to float. At this point, SM 116 may go into a Q2 state. After a clock cycle SM 116 may reach a Q2 state, where it may pull up out_fbc 306 line and reset a rising_ok 314 output signal.

In a particular embodiment, FBCU 300 may comprise NAND 324. An output of NAND 324 may be asserted if there is a failed bit in a byte corresponding to FBCU 300. In a particular embodiment, FBCU 300 may comprise NAND 326 which may generate a falling edge on out_fbc 306 line if an opportune state of FBCU 300 has been reached.

According to a particular embodiment, a negative pulse may be generated on out_fbc 306 line, enabling counter 124 (shown in FIG. 1) to count failed byte signal 304. In successive clock cycles SM 116 may move to a Q3 state, setting the output signal (ennext_ack) 316 and releasing out_fbc 306. On the rising edge of ennext_ack 316, FBCU 300 may reach a Q3 state asserting en_out 310, which in turn may release a token (not shown) enabling a subsequent FBCU to start its own sequence. After Q3, SM 116 may return to Q0, ready to start again. In a particular embodiment, a set of flip-flops (FF1 320 and FF2 322) may store the state of FBCU 300.

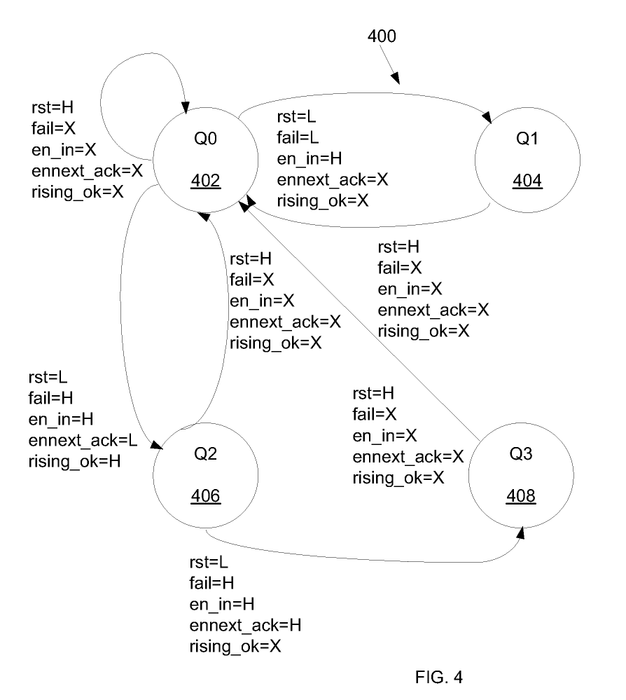

FIG. 4 illustrates an asynchronous state diagram 400 for a particular embodiment of a sequence of FBCUs. In a particular embodiment, a failed byte counting process may start by asserting a start signal for a first FBCU. A start signal may be functionally similar to enable signals (en_ch) for subsequent FBCUs. Therefore, the following detailed discussion describes various states of a first FBCU in a sequence.

In a particular embodiment, a first FBCU in a sequence may start in a Q0 state 402. Q0 state 402 may be a state a first FBCU may be in prior to checking bits of a corresponding byte. According to a particular embodiment, en_out may be low, out_fbc may be floating if en_in is low and out_fbc may be low if en_in is high.

In a particular embodiment, when there are no failed bits in a corresponding byte, an FBCU may enter a Q1 state 404. According to a particular embodiment, going to Q1 state 404 a failed byte signal may be low, en_out may be high and out_fbc may be floating. According to a particular embodiment, an FBCU may be reset to a Q0 state 402 if reset signal goes high.

In a particular embodiment, when there are failed bytes to count in a corresponding byte an FBCU may enter a Q2 state 406. According to a particular embodiment, going to Q2 state 406 a failed byte signal may be high, rising_ok signal may be high, ennext_ack may be low and out_fbc may be floating. According to a particular embodiment, FBCU may be reset to a Q0 state 402 if reset signal goes high.

In a particular embodiment, when a failed bit of corresponding bytes has been counted an FBCU may enter a Q3 state 408 where an enable signal may be sent to a subsequent FBCU to initiate a fail bit counting process. According to a particular embodiment, going to Q3 state 408, a failed byte signal may be high, en_in signal may be high, ennext_ack may be high and out_fbc may be floating and a token may be released to the next FBCU in a sequence. According to a particular embodiment, FBCU may be reset to a Q0 state 402 if reset signal goes high.

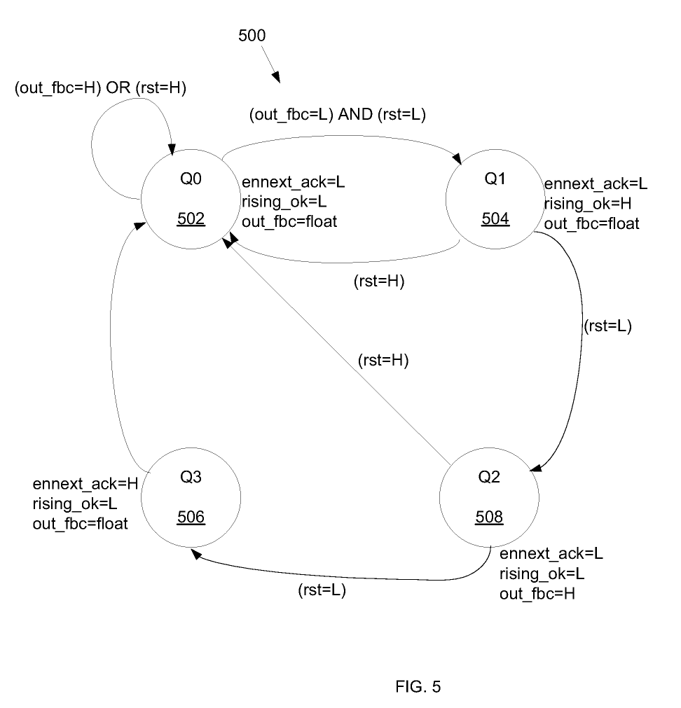

FIG. 5 illustrates a synchronous state diagram 500 for a particular embodiment of a state machine for a particular embodiment of an internal fail bit counting system. In a particular embodiment, a state machine may start in Q0 state 502. According to a particular embodiment, Q0 state 502 may be a reset state in which a state machine is waiting for an out_fbc falling edge and wherein ennext_ack may be low, rising_ok may be low and out_fbc may be floating.

In a particular embodiment, in Q1 state 504 a state machine may avoid activation of pull up pull down MOSFETs on the line out_fbc. In Q1 state 504, ennext_ack may be low, rising_ok may be high and out_fbc may be floating. In a particular embodiment, in Q1 state 504, SM 116 (see FIG. 1) may turn off pull down NMOS 312 (see FIG. 3) in an active FBCU 300 (see FIG. 3), allowing an active FBCU 300 to move to a subsequent state.

In a particular embodiment, in Q2 state 508, SM 116 may pull up line out_fbc. In Q2 state 508, ennext_ack may be low, rising_ok may be low and out_fbc may be high. In a particular embodiment, in Q2 state 508 SM 116 may pull up line out_fbc. According to a particular embodiment, a fail may be counted at a rising edge of out_fbc or on a falling edge depending on clock polarity of a byte counter and claimed subject matter is not limited in this regard.

In a particular embodiment, for Q3 state 506, SM 116 may go into this state to acknowledge a release of a token to a subsequent FBCU 300 and assert a release signal ennext_ack. In Q3 state 506, ennext_ack may be high, rising_ok may be low and out_fbc may be floating.

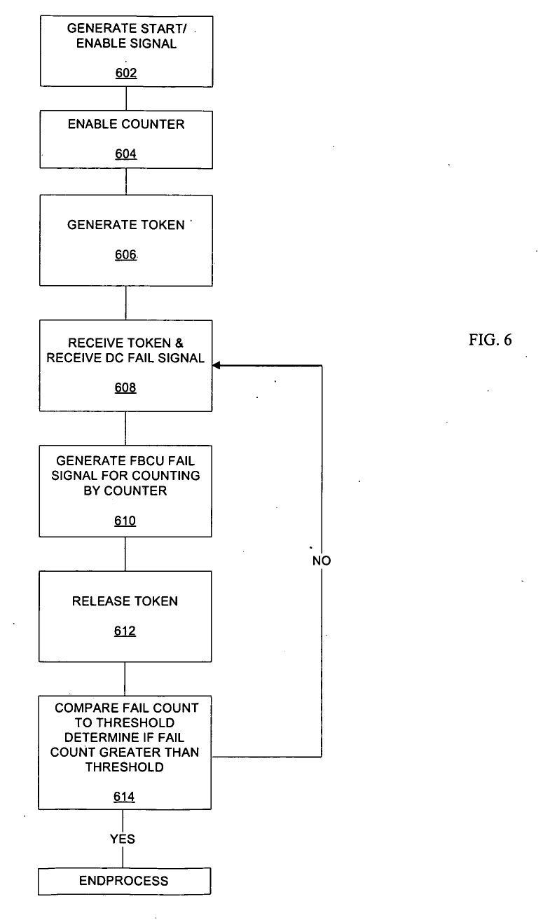

FIG. 6 illustrates a particular embodiment of an internal fail bit counting process 600. Process 600 may begin at block 602 where a start or enable signal may be generated. Process 600 may flow to block 604 where a counter may be enabled to count failed byte signals generated in process 600. In a particular embodiment, process 600 may flow to block 606 where a token may be generated. Process 600 may flow to block 608 where a token may be received and where a failed byte signal indicating that at least one bit of an evaluate byte is improperly programmed or not programmed may be received. According to a particular embodiment, process 600 may flow to block 610 where a second failed byte signal may be generated and sent to a counter to be counted. Process 600 may flow to block 612 where a token may be released. Process 600 may flow to block 614 where a counter may compare a number of failed bytes to a threshold value. At block 614, if the failed byte count is below a threshold value process 600 may return to block 608 to repeat that portion of process 600, if the failed byte count is equal to or greater than a threshold value, process 600 may flow to block 616 where process 600 may end.

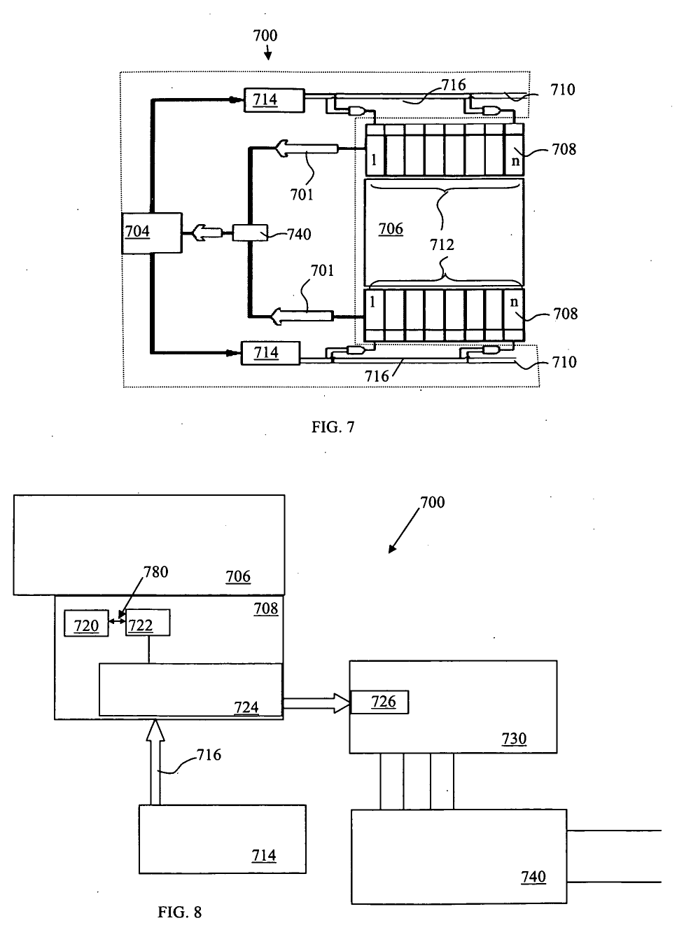

FIG. 7 illustrates a particular embodiment of a memory device 700 comprising a circuit 701 for determining a number of failed bits in a memory array 706. In a particular embodiment, in memory device 700 common bit lines may be read and written by dynamic data cache (DDC) 708 numbered 1−n. According to a particular embodiment, column selector 714 on column select lines (CSL) 710 may select a subset of bit lines (BL). In a particular embodiment, for example, eight BLs may be selected to form one byte. CSL 710 may connect 1−n DDC 708 to data line (DL) 716 to communicate with external I/O pad for read or write operations.

In a particular embodiment, failing bits may be detected using data line 716 to read failed byte signals. According to a particular embodiment, during a fail bit counting operation control unit 704 may scan byte by byte over 1−n bytes 712 to count a number of failed bits. In a particular embodiment, control unit 704 may scan, for instance, during a test phase or during a self error detect phase and claimed subject matter is not limited in this regard.

In a particular embodiment, control unit 704 may be included in firmware of memory device 700. According to a particular embodiment, control unit 704 may manage a fail bit counting operation via internal firmware reducing reliance on an external testing unit.

FIG. 8 illustrates a particular embodiment of an internal fail bit counter 700 comprising memory array 706, DDC 708, counter unit 730, adder unit 740 and column selector 714. According to a particular embodiment, DDC 708 block may comprise a primary data cache (PDC) 720, secondary data cache (SDC) 722 and comparison circuit (COMP) 724. In a particular embodiment, data on PDC 720 may be transferred to SDC 722 to enable failed bit and/or byte detection by COMP 724. In a particular embodiment, COMP 724 may detect one or more failing bits and/or bytes read from SDC 722 via a data line 716.

In a particular embodiment, data line 716 may be used to access data to read and count a number of failed bits and or bytes. According to a particular embodiment, data to be read are on PDC 720, however data line 716 is coupled to SDC 720. In a particular embodiment, SDC 722 may be a latch of DDC 708 used to write data and read data into DDC 708. According to a particular embodiment, PDC 720 may be an internal latch of DDC 708 used to store (bit by bit) pass/fail information.

Data line 716 may be accessed to read pass/fail information from DDC 708 using SDC 722 as an access point by swapping data between SDC 722 and PDC 720. In a particular embodiment, pass/fail data on PDC 722 may be transferred to SDC 722 via bitline 780 and memory data on SDC 722 may be transferred to PDC 720 via bitline 780. Accordingly, reading failed byte signals from SDC 722 by swapping data from PDC 720 and SDC 722 via bitline 780 may enable use of data line 716 to read and count fail bit/byte data without incurring loss of SDC 722 data. However, this is merely an example of a method of swapping data between an SDC and PDC and claimed subject matter is not so limited.

In a particular embodiment, COMP 724 may be coupled to data detect circuit 726 and/or counter unit 730. According to a particular embodiment, COMP 724 may detect bit and/or byte fail conditions and may be enable one or more operations such as, for instance, a compare failed bit operation and a compare failed byte operation and claimed subject matter is not limited in this regard. According to a particular embodiment, a compare failed byte operation may enable detection of a byte fail without any reference to a specific bit location. In a particular embodiment, a compare failed bit operation may enable detection of specific bit within a byte.

In a particular embodiment, if no fail condition is detected, such a ‘no fail’ condition may be indicated, for instance, on a common line data verify of data detect circuit 726. A data verify line may be activated high and stay high when there is a ‘no fail’ condition. In a particular embodiment, if at least one fail condition is detected in comparison circuit 724 of enabled DDC 708, a common line data verify of data detect circuit 726 of a particular byte 712 (see FIG. 7) may be deactivated to low to indicate a failed bit and/or byte has been detected. In a particular embodiment, counter unit 730 may count a fail signal and the number of fail signals may be summed in adder unit 740. According to a particular embodiment, adder unit 740 may compare a fail signal sum to a threshold number, of tolerated fails to determine whether the sum of failed bit/byte signals detected is below the threshold number of tolerated fails. However, this is merely an example of a method of counting, summing and comparing detected fail signals in an internal fail bit counter and claimed subject matter is not so limited.

In a particular embodiment, after swapping data on PDC 720 and SDC 722, 1−n bytes 712 may be addressed. According to a particular embodiment, byte 712 may be evaluated and a detected fails may be counted by counter unit 730. In a particular embodiment, a number of fails over 1−n bytes 712 may be summed by adder unit 740. Summing may be done by adding a current fail to a previous one. Such an internal fail bit/byte counting operation may be performed in user mode during a program phase, by evaluating the result of a previous program verify and/or during a self error detect of a test phase. In a particular embodiment, during a test phase an internal fail bit/byte counting operation may enable determination of the number of fails in a 512 byte array sector.

Error correction coding may be able to correct a particular number of bit fails in a particular byte sector (for example, eight bit fails in a 512 byte sector). In conventional external fail bit/byte counting operations redundant bytes resulting from self error correction may be counted resulting in inaccurate fail bit/byte counts. For example, conventionally some failed bytes may be replaced by redundant columns, however, a specific redundant byte may not be correlated with a specific sector. For instance, redundant byte “0” may be used for byte 12 (first sector) or byte 700 (second sector). In this case, a conventional external fail bit/byte counter may inaccurately count bit fails in the first sector due to redundancy.

In a particular embodiment, an internal fail bit/byte counting operation may simplify fail bit/byte counting because when a failed bit/byte is addressed, internal fail bit/byte counter 700 evaluates fail bit/bytes from information originating on PDC 720 and may evaluate a redundant bit/byte wherever it is placed. For instance, when evaluating fails in a first sector, starting from address 0 up to address 511, if byte 12 fails, when byte 12 is addressed it may be the redundant byte that is evaluated. Therefore, a number of fails counted in a particular sector does not include an original fail bit/byte and a redundant bit/byte, only a redundant bit/byte may be evaluated. If byte 700 is a first failed byte, during counting of a first sector (from 0 to 511) redundant bytes in a second sector are not evaluated.

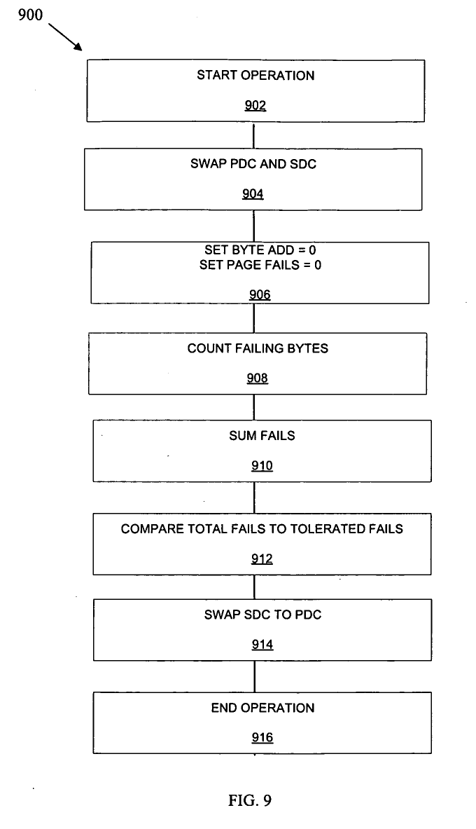

FIG. 9 depicts a particular embodiment of an internal fail bit/byte counting process 900. At block 902, process 900 may start. Process 900 may run during a program operation, by evaluating the result of a previous program verify and/or during a self error detect operation. In a particular embodiment, process 900 may flow to block 904 where data to be read on PDC may be transferred to SDC and data from SDC may be transferred to PDC via a bitline connecting SDC and PDC.

According to a particular embodiment, process 900 may flow to block 906 where an adder unit may be set to zero and a counter unit may be set to zero. In a particular embodiment, process 900 may flow to block 908 where a byte counting operation may occur. During such an operation bytes may be addressed via a data line coupled to a secondary data cache. According to a particular embodiment, failed bits and/or bytes may be detected by a comparison circuit.

According to a particular embodiment, process 900 may flow to block 910 where a counter unit may count failed bytes. In a particular embodiment, a failed bit and/or byte may generate a signal in a data detection circuit to detect fails. Detected fails in a particular block of data may be counted by a counter unit. Process 900 may flow to block 912 where total fails for a page may be summed in an adder unit and compared with a reference value (for example, max fail bits tolerated=20, if the number of fails=18 then ‘pass’ if the number of fails=25 then ‘fail’). Process 900 may flow to block 914 where data on PDC may be transferred back to SDC and data on SDC may be transferred back to PDC. Process 900 may end at block 916.

While certain features of claimed subject matter have been illustrated as described herein, many modifications, substitutions, changes and equivalents will now occur to those skilled in the art. It is, therefore, to be understood that the appended claims are intended to cover all such embodiments and changes as fall within the spirit of claimed subject matter.

What is claimed is:

1. An apparatus comprising:
an array of non-volatile memory cells;
a memory buffer coupled to the memory array and operable to determine if at least one bit of a byte is improperly programmed;
a first failed byte counting unit coupled to the memory buffer, the first failed byte counting unit operable to;
receive a first failed byte signal from the memory buffer; and
generate a token or receive a token, or combinations thereof wherein the token is operable to generate a second failed byte signal indicating a failed byte in response to receiving the first failed byte signal;
a state machine operable to control propagation of the token from a first failed byte counting unit to a second failed byte counting unit; and
a counter operable to receive and count the second failed byte signal.

2. The apparatus of claim 1 wherein the array of non-volatile memory cells comprises an array of a NAND flash memory.

3. The apparatus of claim 1 wherein the second failed byte counting unit is coupled to the first failed byte counting unit via an enable signal chain wherein;
the enable signal chain is operable to propagate the token from the first fail byte counting unit to the second failed byte counting unit;
the first fail byte counting unit is operable to generate an enable signal to release the token be received by the second failed byte counting unit; and
wherein the token is operable to initiate a failed byte counting sequence in the second fail byte counting unit.

4. The apparatus of claim 1 wherein the state machine is further operable to act as a sequencer wherein if the first failed bit counting unit does not receive a first failed byte signal sequencing does not start.

5. The apparatus of claim 1 further comprising a first flip-flop coupled to a second flip-flip operable to store a state of the first fail byte counting unit.

6. The apparatus of claim 3 wherein the counter is further operable to;
count one or more second failed byte signals received from the first failed byte counting unit or the second failed byte counting unit, or combinations thereof; and
communicate a number of failed bytes to a processor for comparing the number of failed bytes to a threshold number of failed bytes.

7. The apparatus of claim 1 wherein the first fail byte counting unit further comprises a pull down NMOS operable generate the second fail byte signal.

8. A process comprising:
receiving a start signal to enable a fail byte counting process;
generating a token in response to receiving the start signal;
receiving a first failed byte signal indicating that at least one bit of an evaluated byte is improperly programmed;
generating a second failed byte signal in response to receiving the first failed byte signal;
enabling a counter to count the second failed byte signal;
sending the second failed byte signal to the counter to be counted;
releasing the token to enable subsequent fail byte counting processes; and
calculating a total of second failed byte signals.

9. The process of claim 8 further comprising comparing the total of second failed byte signals to a threshold number of tolerated failed byte signals

10. The process of claim 9 further comprising determining whether the number of second fail byte signals exceeds the threshold number of tolerated failed byte signals.

11. A process comprising:
transferring a first data set from a primary data cache to a secondary data cache;
transferring a second data set from a secondary data cache to a primary data cache;
selecting a byte of data from the first data set via a data line coupled to a secondary data cache;
evaluating the byte to determine if the byte is a failed byte by detecting if there is at least one failed bit;
counting the failed byte;
summing the failed byte to determine a total of failed bytes;
comparing the total failed bytes to a threshold number of tolerated failed bytes; and
determining if the total failed bytes exceeds the threshold number of tolerated failed bytes.

12. The process of claim 11 wherein determining if the byte is a failed byte by further comprises determining a specific bit location within the failed byte.

13. The process of claim 11 further comprising:
transferring the second data set from the secondary data cache back to the primary data cache; and
transferring first data set from the primary data cache back to the secondary data cache.

14. The process of claim 11 further comprising generating a fail signal if the total failed bytes exceeds the threshold number or generating a pass signal if the total failed bytes does not exceed the threshold number of tolerated failed bytes, or combinations thereof.

15. An apparatus comprising:
an array of non-volatile memory cells;
a primary data cache coupled to the memory array operable to transfer pass/fail data to a secondary data cache;
the secondary data cache coupled to the primary data cache, wherein the secondary data cache is operable to transfer memory data to the primary data cache;
a column selector coupled to the secondary data cache via a data line, wherein the column selector is operable to select a plurality of bit lines from the secondary data cache and wherein the bit lines comprise a byte;
a control unit coupled to the column selector, wherein the control unit is operable to scan one or more bytes to be evaluated; and
a failed byte counter coupled to the secondary data cache, wherein the failed byte counter is operable to count a number of failed bytes from the secondary data cache data, wherein the secondary data cache data originated on the primary data cache.

16. The apparatus of claim 15 wherein the array of non-volatile memory cells is an array of a NAND flash memory device.

17. The apparatus of claim 15 wherein the failed byte counter further comprises a comparison circuit, wherein the comparison circuit is operable to determine whether the byte is a failed byte by evaluating whether the byte contains at least one failed bit.

18. The apparatus of claim 17 further comprising a data detect circuit coupled to the comparison circuit, wherein the data detect circuit is operable to count the failed byte.

19. The apparatus of claim 18 further comprising an adder unit coupled to the data detect circuit, wherein the adder unit is operable to perform a failed byte summing operation to determine a failed byte sum.

20. The apparatus of claim 19 wherein the adder unit may be further operable to compare the sum of failed bytes to a threshold number of tolerated failed bytes.
